(19) United States
(12) Patent Application Publication
(10) Pub. No.: US 2022/0383440 A1
(43) Pub. Date: Dec. 1, 2022

(54) COMPUTER-READABLE RECORDING MEDIUM STORING INFORMATION COLLECTION PROGRAM, INFORMATION COLLECTION METHOD, AND INFORMATION PROCESSING APPARATUS

(71) Applicant: FUJITSU LIMITED, Kawasaki-shi (JP)

(72) Inventor: Takashi IKEMORI, Takatsuki (JP)

(73) Assignee: FUJITSU LIMITED, Kawasaki-shi (JP)

(21) Appl. No.: 17/882,692

(22) Filed: Aug. 8, 2022

Related U.S. Application Data
(63) Continuation of application No. PCT/JP2020/014250, filed on Mar. 27, 2020.

(51) Int. Cl. G06Q 50/26; H04L 51/02; G06Q 50/06

(52) U.S. Cl. CPC G06Q 50/265; H04L 51/02; G06Q 50/06; G06F 40/35

(57) ABSTRACT

A non-transitory computer-readable recording medium stores an information collection program for causing a computer to execute processing including: starting, in response to reception of an instruction to start a conversation in a chatbot for disaster from an information processing terminal, a conversation in the chatbot to the information processing terminal; and transmitting, in a case where a captured image is received in the conversation, disaster information that includes the captured image to a disaster countermeasure system on the basis of content of a conversation before the reception of the captured image.

### CROSS-REFERENCE TO RELATED APPLICATION

This application is a continuation application of International Application PCT/JP2020/014250 filed on Mar. 27, 2020 and designated the U.S., the entire contents of which are incorporated herein by reference.

### FIELD

The embodiment discussed herein is related to an information collection program, an information collection method, and an information processing apparatus.

### BACKGROUND

In recent years, large-scale disasters such as typhoons and earthquakes have occurred frequently, and large-scale power failures may be caused, causing enormous damage to lives of residents. For power failures caused by damage to high-voltage lines or the like, real-time alive monitoring is performed by a monitoring system of an electric power company, and when occurrence of a power failure is detected, workers of the electric power company perform recovery work.

Japanese Laid-open Patent Publication No. 2018-165924 and Japanese Laid-open Patent Publication No. 2019-185159 are disclosed as related art.

### SUMMARY

According to an aspect of the embodiments, a non-transitory computer-readable recording medium stores an information collection program for causing a computer to execute processing including: starting, in response to reception of an instruction to start a conversation in a chatbot for disaster from an information processing terminal, a conversation in the chatbot to the information processing terminal; and transmitting, in a case where a captured image is received in the conversation, disaster information that includes the captured image to a disaster countermeasure system on the basis of content of a conversation before the reception of the captured image.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating a system configuration example of an information collection system 100;

FIG. 2 is a block diagram illustrating a hardware configuration example of an information processing apparatus 101;

FIG. 3 is a block diagram illustrating a hardware configuration example of an information processing terminal 102;

FIG. 4 is an explanatory diagram illustrating an example of contents stored in a user information database (DB) 120;

FIG. 5 is an explanatory diagram illustrating an example of contents stored in a power failure information DB 130;

FIG. 6 is an explanatory diagram illustrating a specific example of a talk script;

FIG. 7 is a block diagram illustrating a functional configuration example of the information processing apparatus 101;

FIG. 8A is an explanatory diagram (part 1) illustrating a screen example of a chat screen;

FIG. 8B is an explanatory diagram (part 2) illustrating the screen example of the chat screen;

FIG. 9 is an explanatory diagram illustrating an operation example of the information collection system 100;

FIG. 10 is a flowchart (part 1) illustrating an example of an information collection processing procedure of the information processing apparatus 101;

FIG. 11 is a flowchart (part 2) illustrating the example of the information collection processing procedure of the information processing apparatus 101; and

FIG. 12 is a flowchart (part 3) illustrating the example of the information collection processing procedure of the information processing apparatus 101.

### DESCRIPTION OF EMBODIMENTS

For example, there is a technology in which position information of each facility is associated with an opened chat room, and on the basis of the position information of each facility, each object indicating existence of each chat room is displayed at a position of each facility in a map including each facility in a state where content of each chat may be selectively browsed. Furthermore, there is a technology in which, from a terminal device to a server device, a character text for an utterance that has been input in relation to an event is transmitted, and site information including a position on a map, which has been input in relation to an event occurrence site, is transmitted, and in the server device, the received utterance is recorded in a recording unit, and the received site information is recorded in the recording unit.

However, in the prior arts, there is a problem that it is difficult to detect a power failure locally caused due to damage of a service line to a home, or the like, which is a so-called hidden power failure, and a delay occurs in recovery work by an electric power company, and a period until recovery is prolonged.

In one aspect, an embodiment aims to make it possible to collect useful information for detection of a hidden power failure.

Hereinafter, an embodiment of an information collection program, an information collection method, and an information processing apparatus will be described in detail with reference to the drawings.

### EMBODIMENT

First, a system configuration example of an information collection system 100 including an information processing apparatus 101 according to an embodiment will be described.

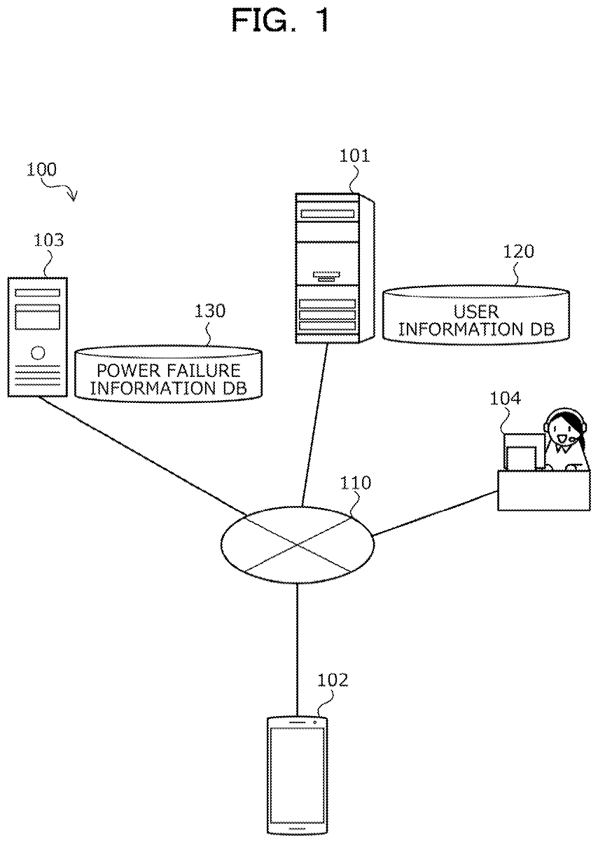

FIG. 1 is an explanatory diagram illustrating the system configuration example of the information collection system 100. In FIG. 1, the information collection system 100 includes the information processing apparatus 101, an information processing terminal 102, a disaster countermeasure system 103, and an operator terminal 104. In the information collection system 100, the information processing apparatus 101, the information processing terminal 102, the disaster countermeasure system 103, and the operator terminal 104 are connected via a wired or wireless network 110. The network 110 is, for example, a local area network (LAN), a wide area network (WAN), or the Internet.

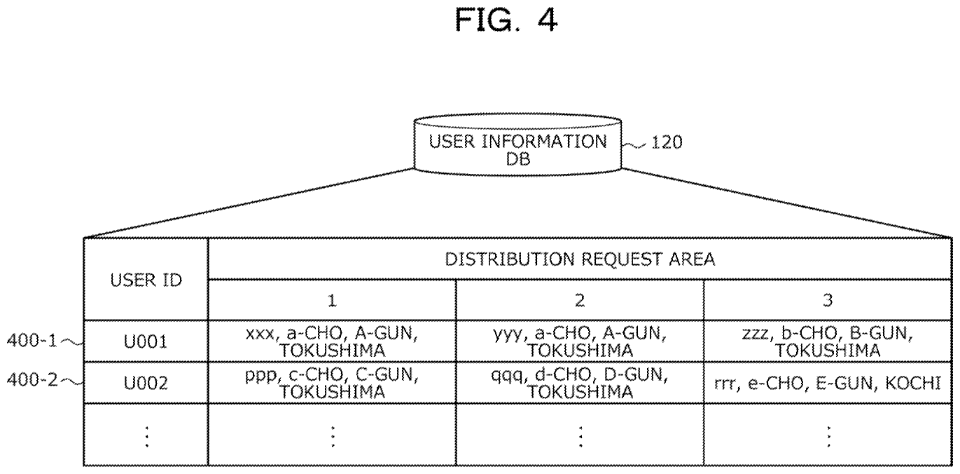

Here, the information processing apparatus 101 is a computer that controls a conversation of a chatbot for disaster. The chatbot is a computer system that interacts with and exchanges messages with humans using artificial intelligence. The disaster is a disaster caused by a natural phenomenon, an accident, an infectious disease, and the like, such as a typhoon, an earthquake, a heavy snowfall, a wind disaster, a fire, and a flood disaster, for example. The information processing apparatus 101 includes a user information database (DB) 120. Contents stored in the user information DB 120 will be described later with reference to FIG. 4. The information processing apparatus 101 is, for example, a server.

The information processing terminal 102 is a computer that a user uses to have a conversation with the chatbot. The information processing terminal 102 is, for example, a smartphone, a tablet personal computer (PC), or a PC. In the information processing terminal 102, the user may search for a desired answer or upload information while interacting with the chatbot by, for example, inputting a message or selecting an option.

The answer is, for example, a frequently asked question (FAQ). The FAQ means “frequently asked questions”, and is a collection of questions and answers for questions expected in advance. The question may ask for a solution method to some problem, or the question may be a spoken question. The answer is an answer indicating a solution method to the asked problem, an answer to the spoken question, or the like.

Note that, although not illustrated, the information processing apparatus 101 includes, for example, an FAQ master and a chat log DB. The FAQ master stores an FAQ. The chat log DB stores a chat log. The chat log is a conversation history regarding a conversation between a user and the chatbot. The chat log is stored in the chat log DB in association with, for example, a room identifier (ID). The room ID may specify a series of conversations with the chatbot.

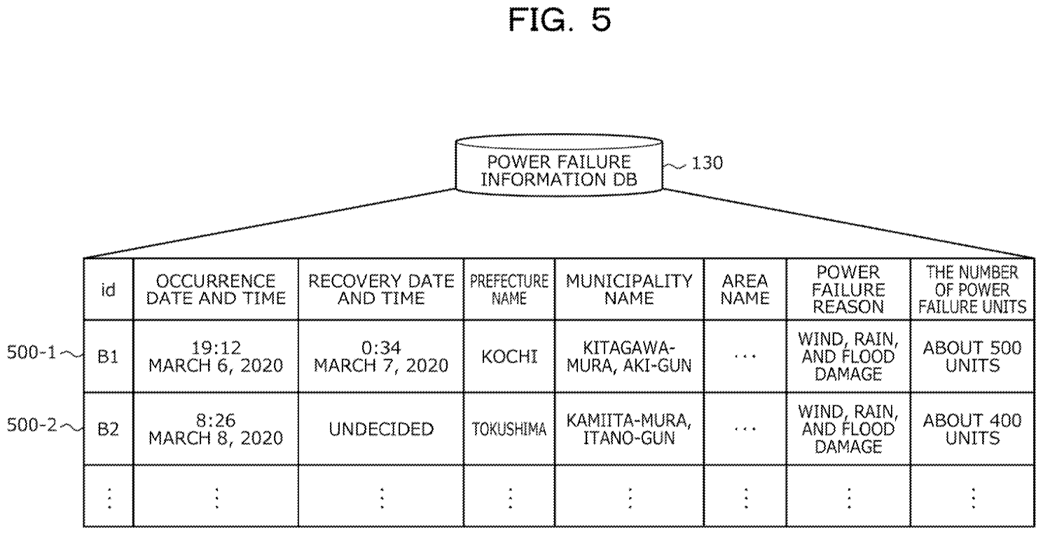

The disaster countermeasure system 103 is a computer system corresponding to an electric power company. The electric power company is a company whose main business is electric power supply business, and which performs generation, distribution, transmission, and the like of electric power. The disaster countermeasure system 103 includes a power failure information DB 130, and detects a power failure caused by damage to a high-voltage line, or the like. Contents stored in the power failure information DB 130 will be described later with reference to FIG. 5.

The operator terminal 104 is a computer that an operator uses. The operator is a person who responds to a user when a conversation is switched from a conversation by the chatbot to a manned conversation. For example, the operator may communicate with the user by using a telephone function of the operator terminal 104, text communication, or the like. The operator terminal 104 is, for example, a PC or a tablet PC.

Note that, in the example of FIG. 1, only one information processing terminal 102 or operator terminal 104 is illustrated, but the information collection system 100 includes a plurality of the information processing terminals 102 or operator terminals 104.

Here, real-time alive monitoring of a high-voltage line that sends a high-voltage current from a substation is performed by a monitoring system (for example, the disaster countermeasure system 103) of an electric power company. On the other hand, alive monitoring of a service line to a home (including a low-voltage line that sends a low-voltage current from a transformer of a utility pole) is not performed by the monitoring system of the electric power company.

Thus, when a service line to a home is damaged by strong wind, a fallen tree, or the like, a local power failure occurs. Such a power failure is called a hidden power failure because the power failure may not be detected by the monitoring system of the electric power company. When a hidden power failure occurs, a delay occurs in recovery work by the electric power company and a period until recovery is prolonged, which have become a major social problem.

For example, when appropriate information is provided by residents at the time of occurrence of a disaster, an electric power company may grasp occurrence of a hidden power failure, formulate a recovery plan, and provide accurate information to residents. However, when a large-scale power failure occurs due to a large-scale disaster, many residents inquire about a cause of the power failure, a recovery time, and the like, so access to a call center is concentrated in many cases, resulting in a full-capacity state.

For example, when a large-scale disaster or the like occurs, a call center does not function properly, and information is divided between residents and an electric power company, resulting in a prolonged recovery period. When there is a mechanism that enables two-way communication between residents and an electric power company even at the time of occurrence of a disaster, it is possible to collect useful information in a timely manner.

Therefore, in the present embodiment, description will be made for an information collection method that enables collection of useful information for detection of a hidden power failure that may not be detected by a monitoring system of an electric power company by enabling real-time transmission of information from residents to the electric power company using two-way communication linked with a chatbot.

(Hardware Configuration Example of Information Processing Apparatus 101)

Next, a hardware configuration example of the information processing apparatus 101 will be described.

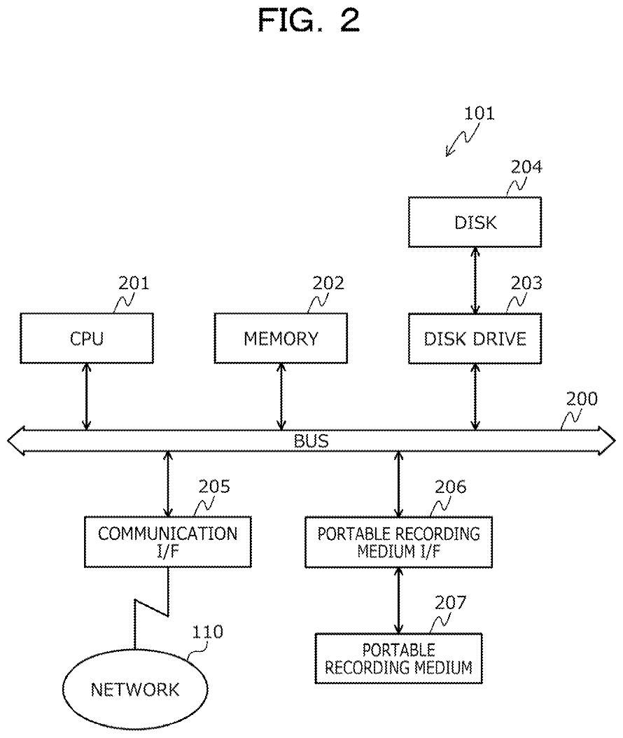

FIG. 2 is a block diagram illustrating the hardware configuration example of the information processing apparatus 101. In FIG. 2, the information processing apparatus 101 includes a central processing unit (CPU) 201, a memory 202, a disk drive 203, a disk 204, a communication interface (I/F) 205, a portable recording medium I/F 206, and a portable recording medium 207. Furthermore, the respective components are connected to each other by a bus 200.

Here, the CPU 201 performs overall control of the information processing apparatus 101. The CPU 201 may include a plurality of cores. The memory 202 includes, for example, a read only memory (ROM), a random access memory (RAM), and a flash ROM. For example, the flash ROM stores an operating system (OS) program, the ROM stores an application program, and the RAM is used as a work area for the CPU 201. The program stored in the memory 202 is loaded to the CPU 201 to cause the CPU 201 to execute coded processing.

The disk drive 203 controls reading/writing of data from/to the disk 204 under the control of the CPU 201. The disk 204 stores data written under the control of the disk drive 203. Examples of the disk 204 include a magnetic disk and an optical disk.

The communication I/F 205 is connected to the network 110 through a communication line, and is connected to an external computer (for example, the information processing terminal 102, the disaster countermeasure system 103, or the operator terminal 104 illustrated in FIG. 1) via the network 110. Then, the communication I/F 205 manages an interface between the network 110 and the inside of the device, and controls input and output of data from the external computer. For example, a modem or a LAN adapter may be adapted as the communication I/F 205.

The portable recording medium I/F 206 controls reading/writing of data from/to the portable recording medium 207 under the control of the CPU 201. The portable recording medium 207 stores data written under the control of the portable recording medium I/F 206. Examples of the portable recording medium 207 include a compact disc (CD)-ROM, a digital versatile disk (DVD), or a universal serial bus (USB) memory.

Note that the information processing apparatus 101 may include, for example, a solid state drive (SSD), an input device, or a display in addition to the components described above. Furthermore, the information processing apparatus 101 does not need to include, for example, the disk drive 203, the disk 204, the portable recording medium I/F 206, and the portable recording medium 207 among the components described above. Furthermore, the disaster countermeasure system 103 illustrated in FIG. 1 may also be implemented by a hardware configuration similar to that of the information processing apparatus 101.

(Hardware Configuration Example of Information Processing Terminal 102)

Next, a hardware configuration example of the information processing terminal 102 will be described.

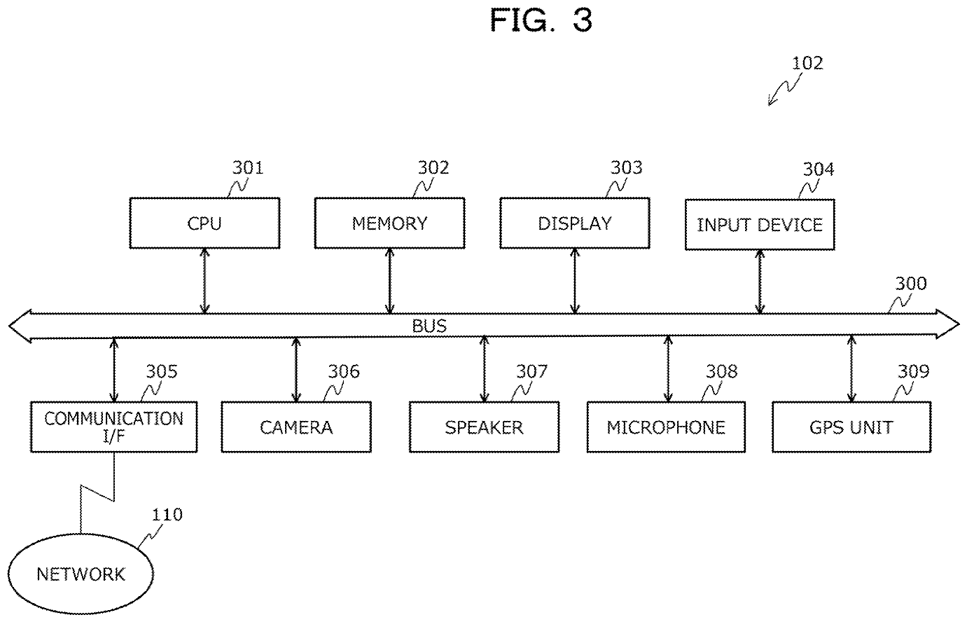

FIG. 3 is a block diagram illustrating the hardware configuration example of the information processing terminal 102. In FIG. 3, the information processing terminal 102 includes a CPU 301, a memory 302, a display 303, an input device 304, a communication I/F 305, a camera 306, a speaker 307, a microphone 308, and a global positioning system (GPS) unit 309. Furthermore, the respective components are connected to each other by a bus 300.

Here, the CPU 301 performs overall control of the information processing terminal 102. The CPU 301 may include a plurality of cores. The memory 302 is a storage unit including, for example, a ROM, a RAM, and a flash ROM. For example, the flash ROM or the ROM stores various programs, and the RAM is used as a work area for the CPU 301. The program stored in the memory 302 is loaded to the CPU 301 to cause the CPU 301 to execute coded processing.

The display 303 is a display device that displays data such as a document, an image, or functional information, as well as a cursor, an icon, or a tool box. For example, a liquid crystal display or an organic electroluminescence (EL) display may be adapted as the display 303.

The input device 304 includes keys for inputting characters, numbers, various instructions, and the like, and inputs data. The input device 304 may be a touch-panel input pad, a numeric keypad, or the like, or may be a keyboard, a mouse, or the like.

The communication I/F 305 is connected to the network 110 through a communication line, and is connected to an external computer (for example, the information processing apparatus 101 or the operator terminal 104) via the network 110. Then, the communication I/F 305 manages an interface between the network 110 and the inside of the own device, and controls input and output of data from the external device.

The camera 306 is an image capturing device that captures an image (still image or moving image) and outputs image data. The speaker 307 converts an electrical signal into a sound, and outputs the sound. The microphone 308 receives a sound, and converts the sound into an electrical signal.

The GPS unit 309 receives radio waves from a GPS satellite, and outputs position information of the information processing terminal 102. The position information of the information processing terminal 102 is information such as latitude and longitude that specifies one point on the earth, for example. Furthermore, as the satellite, a satellite of a quasi-zenith satellite system may be used, for example.

Note that the information processing terminal 102 may include, for example, a hard disk drive (HDD), an SSD, a short-range wireless communication I/F, a portable recording medium I/F, or a portable recording medium, in addition to the components described above. Furthermore, the operator terminal 104 illustrated in FIG. 1 may also be implemented by a hardware configuration similar to that of the information processing terminal 102.

(Contents Stored in User Information DB 120)

Next, contents stored in the user information DB 120 included in the information processing apparatus 101 will be described with reference to FIG. 4. Note that the user information DB 120 is implemented by a storage device such as the memory 202 or the disk 204 illustrated in FIG. 2, for example.

FIG. 4 is an explanatory diagram illustrating an example of the contents stored in the user information DB 120. In FIG. 4, the user information DB 120 has fields of a user ID and a distribution request area, and stores user information (for example, user information 400-1 and 400-2) as a record by setting information in each field.

Here, the user ID is an identifier that uniquely identifies a user. The user is, for example, a resident (consumer) who receives electric power supply. As the user ID, for example, an ID or a telephone number that may specify an individual user in a communication tool (chat application) may be used.

In the user information DB 120, a user ID of a user who is using a power failure information distribution service and has already registered a distribution request area is registered. The power failure information distribution service is a service that notifies power failure information of the distribution request area by push notification. Here, up to three areas 1, 2, and 3 may be registered as distribution request areas.

For example, the user information 400-1 indicates the distribution request area 1 “xxx, a-cho, A-gun, Tokushima”, the distribution request area 2 “yyy, a-cho, A-gun, Tokushima”, and the distribution request area 3 “zzz, b-cho, B-gun, Tokushima” of a user ID “U001”.

(Contents Stored in Power Failure Information DB 130)

Next, contents stored in the power failure information DB 130 included in the disaster countermeasure system 103 will be described with reference to FIG. 5. Note that the power failure information DB 130 is implemented by a storage device such as the memory or the disk of the disaster countermeasure system 103, for example.

FIG. 5 is an explanatory diagram illustrating an example of the contents stored in the power failure information DB 130. In FIG. 5, the power failure information DB 130 has fields of an id, an occurrence date and time, a recovery date and time, a prefecture name, a municipality name, an area name, a power failure reason, and the number of power failure units, and stores power failure information (for example, power failure information 500-1 and 500-2) as a record by setting information in each field.

Here, id is an identifier that uniquely identifies power failure information. The occurrence date and time indicates a date and time when a power failure has occurred. The recovery date and time indicates a date and time when the power failure has been recovered. The prefecture name indicates a name of a prefecture where the power failure has occurred. The municipality name indicates a name of a municipality where the power failure has occurred. The area name indicates a name of an area where the power failure has occurred. The power failure reason indicates a reason why the power failure has occurred. The number of power failure units indicates the number of units in which the power failure is occurring.

In the power failure information DB 130, for example, power failure information regarding a power failure due to damage to a high-voltage line, or the like detected by alive monitoring in the disaster countermeasure system 103 is registered. Furthermore, in the power failure information DB 130, power failure information regarding a hidden power failure detected on the basis of disaster information from the information processing apparatus 101 in the disaster countermeasure system 103 may be registered.

Note that the contents stored in the power failure information DB 130 are updated at a time interval of, for example, about 5 minutes. At this time, the power failure information regarding the recovered power failure is deleted from the power failure information DB 130.

(Specific Example of Talk Script)

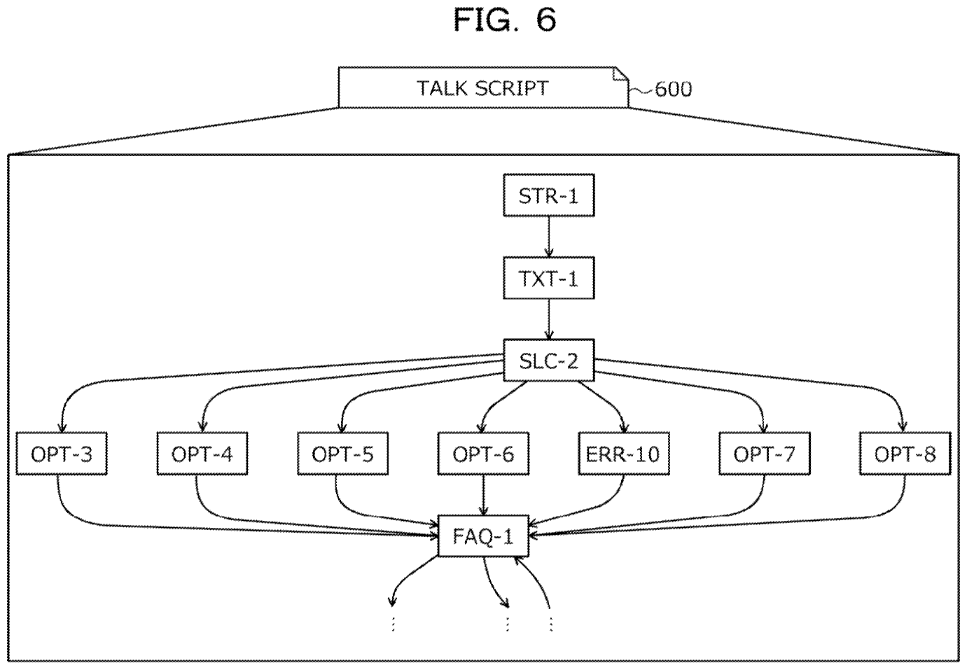

Here, a specific example of a talk script will be described with reference to FIG. 6. The talk script is information (scenario) that defines a flow of a conversation of the chatbot.

FIG. 6 is an explanatory diagram illustrating the specific example of the talk script. In FIG. 6, a talk script 600 is information (scenario) that defines a flow of a conversation of the chatbot. Note that a part of the talk script 600 is excerpted and displayed in FIG. 6.

For example, the talk script 600 is information that defines chat talk processing. The talk processing is processing for implementing an operation (behavior) of the chatbot. For example, the talk processing includes processing of speaking, processing of displaying options, processing of selecting an option according to a user operation, processing of performing a procedure according to the selected option or input information, processing of terminating the talk processing, and the like.

In the talk script 600, for example, STR-1 indicates start of the talk processing. TXT-1 indicates processing of speaking a message. SLC-2 indicates processing of displaying options of OPT-3 to OPT-8. FAQ-1 indicates processing of searching for and displaying an FAQ according to the option. Note that ERR-10 indicates error processing. The search for an FAQ is performed by using, for example, an FAQ master (not illustrated) included in the information processing apparatus 101.

(Functional Configuration Example of Information Processing Apparatus 101)

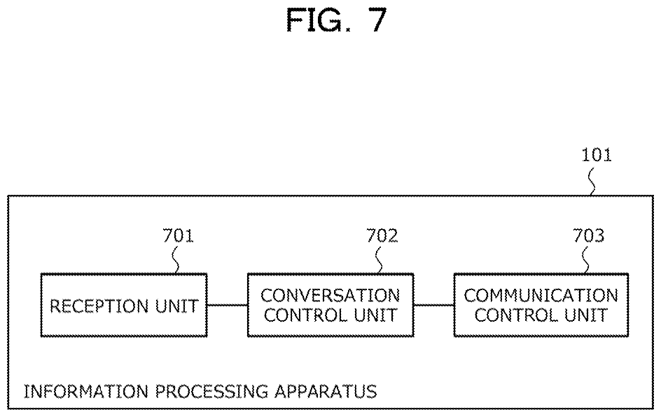

FIG. 7 is a block diagram illustrating a functional configuration example of the information processing apparatus 101. In FIG. 7, the information processing apparatus 101 includes a reception unit 701, a conversation control unit 702, and a communication control unit 703. For example, the reception unit 701 to the communication control unit 703 implement the functions by causing the CPU 201 to execute a program stored in a storage device such as the memory 202, the disk 204, or the portable recording medium 207 illustrated in FIG. 2, or by the communication I/F 205. A processing result of each functional unit is stored in, for example, a storage device such as the memory 202 or the disk 204.

The reception unit 701 receives an instruction to start a conversation in the chatbot for disaster from the information processing terminal 102. Here, the instruction to start a conversation is for starting a conversation between a user and the chatbot. In the chatbot for disaster, for example, a conversation to answer a question regarding a disaster or to prompt input of information regarding a disaster is performed.

For example, the instruction to start a conversation is given by operation input of a user at the information processing terminal 102, and is transmitted from the information processing terminal 102 to the information processing apparatus 101. For example, the reception unit 701 receives the instruction to start a conversation in the chatbot for disaster by receiving the instruction to start a conversation in the chatbot for disaster from the information processing terminal 102.

The conversation control unit 702 starts a conversation in the chatbot for disaster to the information processing terminal 102 in response to an instruction to start a conversation in the chatbot for disaster from the information processing terminal 102. For example, the conversation control unit 702 starts a conversation in the chatbot for disaster to the information processing terminal 102 by using a talk script that defines a flow of a conversation of the chatbot for disaster.

In the following description, the talk script that defines a flow of a conversation of the chatbot for disaster may be referred to as “talk script TP”. Furthermore, as the talk script TP, a talk script that defines a flow of a conversation that is performed when a power failure occurs due to a disaster will be described as an example. Note that the talk script TP may define a flow of a conversation that is performed when water supply, gas supply, or the like is stopped due to a disaster. The talk script 600 illustrated in FIG. 6 is an example of the talk script TP.

In more detailed description, for example, the conversation control unit 702 uses the chatbot for disaster to speak, display options, receive input of information, and execute a procedure according to the selected option or the input information according to the talk script TP.

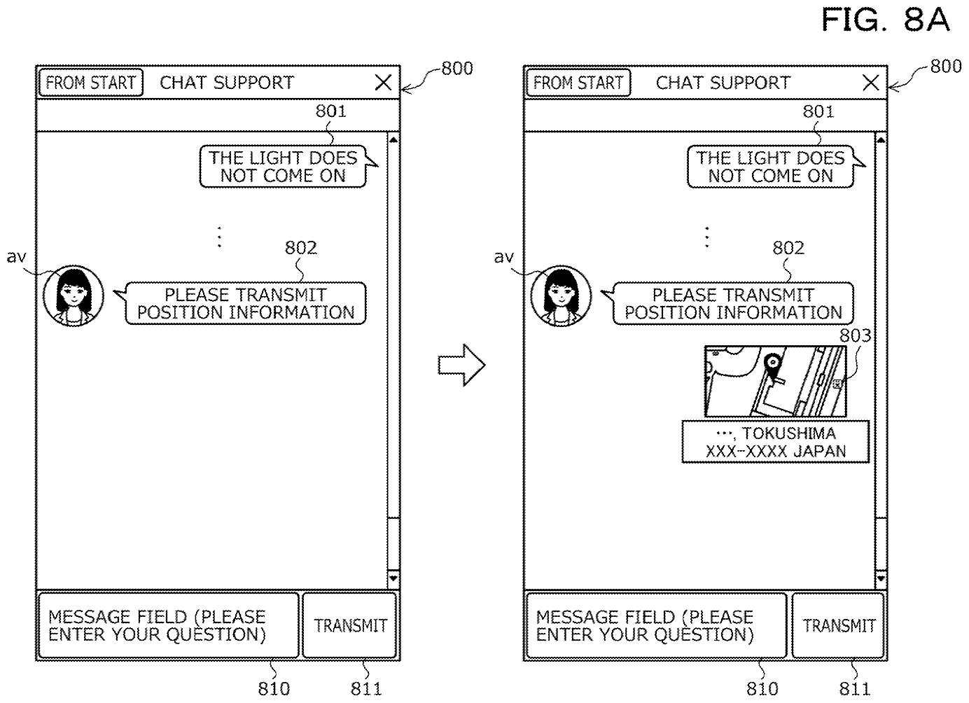

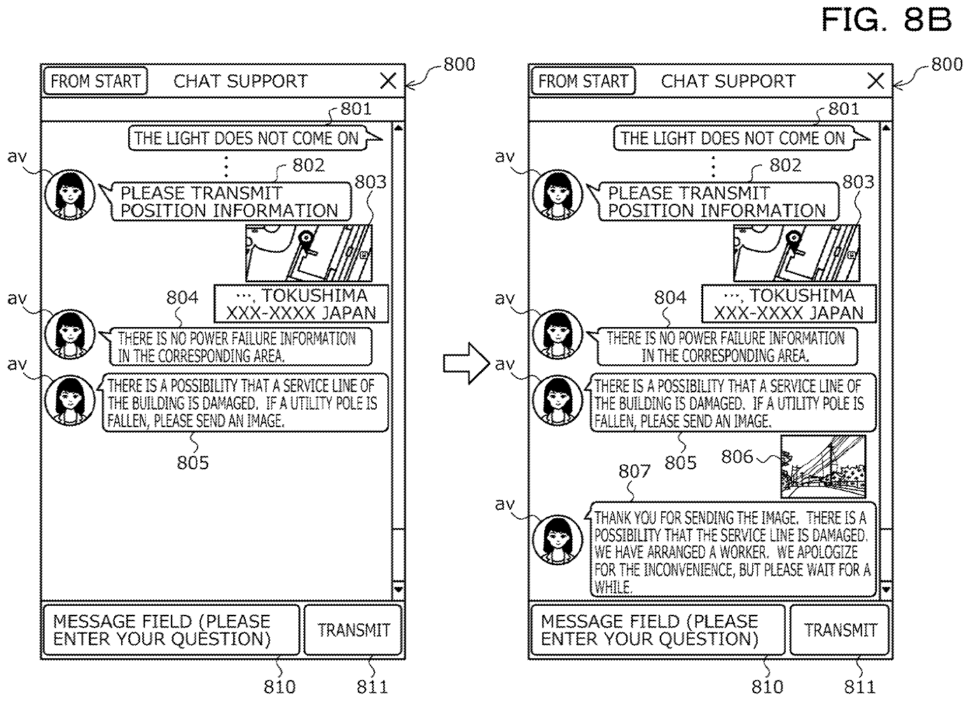

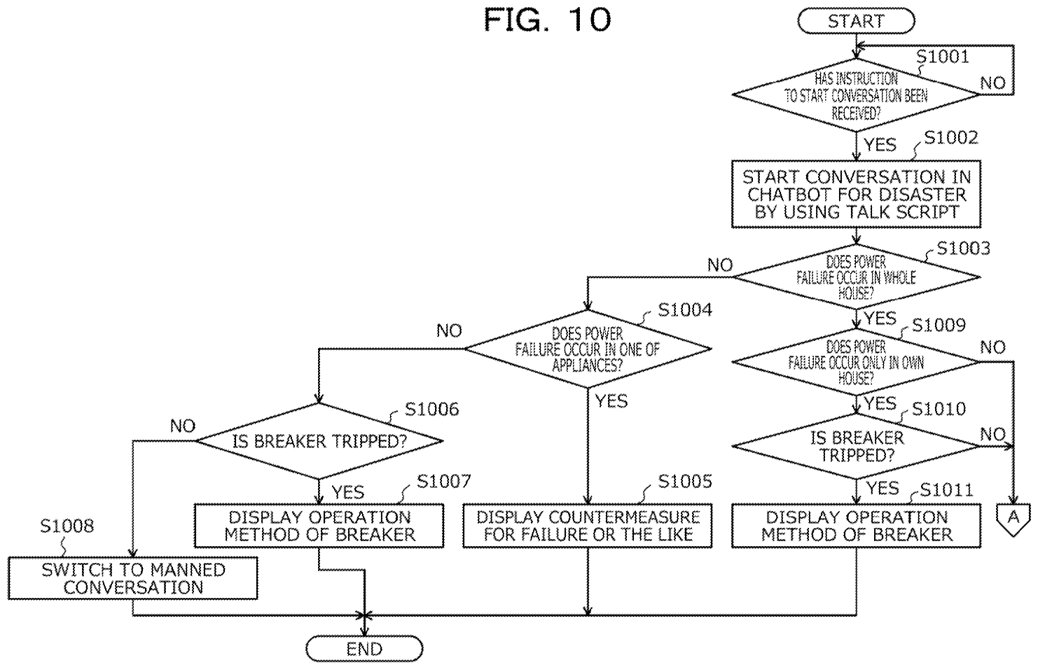

Note that, a screen example of a chat screen that displays a conversation in the chatbot for disaster in the information processing terminal 102 will be described later with reference to FIGS. 8A and 8B. Furthermore, an example of a flow of a conversation of the chatbot for disaster will be described later with reference to flowcharts illustrated in FIGS. 10 to 12.

The communication control unit 703 transmits, in a case where a captured image is received in a conversation in the chatbot for disaster, disaster information including the captured image to the disaster countermeasure system 103 on the basis of content of a conversation before the reception of the captured image. Here, the captured image is a photograph or moving image received from the information processing terminal 102 for a message output in a conversation in the chatbot for disaster. The message is, for example, a message prompting to capture an image of a situation at the site.

In the following description, the captured image received in a conversation in the chatbot for disaster in the information processing terminal 102 may be referred to as “captured image P”. The captured image P is captured by, for example, the camera 306 of the information processing terminal 102 illustrated in FIG. 3.

For example, as a conversation of the chatbot for disaster, a message prompting to capture an image of a service line to a building or an electric facility (such as a utility pole) is output. In this case, the conversation control unit 702 receives a photograph or moving image obtained by capturing the image of the service line to the building or the electric facility in the conversation in the chatbot for disaster in the information processing terminal 102.

The disaster information is information for reporting a situation of an accident or the like caused by a disaster. Examples of the accident caused by a disaster include collapse of a utility pole and disconnection of an electric wire. In addition to the captured image P, the disaster information includes, for example, a user ID of a user of the information processing terminal 102 and position information of the information processing terminal 102.

Note that the user ID may be included in, for example, an instruction to start a conversation in the chatbot for disaster. Furthermore, the user ID may be given to the captured image P or position information received in a conversation in the chatbot for disaster.

The position information of the information processing terminal 102 is received from the information processing terminal 102 for a message output in a conversation in the chatbot for disaster, for example. The message is, for example, a message prompting to transmit the position information. The position information of the information processing terminal 102 is, for example, latitude and longitude output by the GPS unit 309 illustrated in FIG. 3. Furthermore, the position information of the information processing terminal 102 may be, for example, an address or zip code input by a user operation using the input device 304 illustrated in FIG. 3.

Note that content of a conversation in the chatbot for disaster in the information processing terminal 102 is specified from, for example, the chat log DB (not illustrated) included in the information processing apparatus 101.

For example, the communication control unit 703 may transmit disaster information including the captured image P to the disaster countermeasure system 103 in a case where a specific answer is received from the information processing terminal 102 to a predetermined question regarding an occurrence situation of a power failure in a conversation in the chatbot for disaster before reception of the captured image P.

Here, the predetermined question regarding the occurrence situation of the power failure is a question for narrowing down a cause of the occurrence of the power failure by, for example, a conversation in the form of an interview. Furthermore, the specific answer is, for example, an answer that specifies that the cause of the occurrence of the power failure is not an event that may be dealt with by a side of a user. Examples of the event that may be dealt with by the side of the user include a breaker being tripped or a light bulb being burned out.

For example, the communication control unit 703 transmits the disaster information including the captured image P to the disaster countermeasure system 103 in a case where a power failure occurs due to an event that may not be dealt with by the side of the user.

Furthermore, the communication control unit 703 may determine whether or not the position information received before the reception of the captured image P is included in an area for which disaster information is registered in the disaster countermeasure system 103. The disaster information registered in the disaster countermeasure system 103 is information regarding a disaster grasped (detected) in the disaster countermeasure system 103.

For example, the disaster information registered in the disaster countermeasure system 103 is power failure information grasped by an electric power company. Then, the communication control unit 703 may transmit the disaster information including the captured image P to the disaster countermeasure system 103 in a case where it is determined that the position information received before the reception of the captured image P is not included in the area for which the disaster information is registered in the disaster countermeasure system 103.

Furthermore, the communication control unit 703 may transmit the disaster information including the captured image P to the disaster countermeasure system 103 in a case where the received position information is included in an area corresponding to a state indicating recovery from a disaster with reference to information managed by the disaster countermeasure system 103, in which an area and a state of a disaster are associated with each other. The information in which an area and a state of a disaster are associated with each other is, for example, the power failure information DB 130 illustrated in FIG. 5.

In more detailed description, for example, the communication control unit 703 transmits a power failure inquiry including the received position information to the disaster countermeasure system 103. When receiving the power failure inquiry, the disaster countermeasure system 103 determines, with reference to the power failure information DB 130, whether or not there is power failure information corresponding to the position information included in the power failure inquiry.

The power failure information corresponding to the position information is, for example, information regarding a power failure that has occurred in an area including the position information. Here, in a case where there is the power failure information corresponding to the position information, the disaster countermeasure system 103 transmits, to the information processing apparatus 101, an inquiry result (detected) indicating that the occurrence of the power failure in the area indicated by the position information is detected. The inquiry result (detected) may include state information indicating whether or not the power failure (disaster) has been recovered. For example, in a case where a recovery date and time of the power failure information is set, the inquiry result (detected) includes state information indicating that the power failure has been recovered. In a case where the recovery date and time of the power failure information is undetermined, the inquiry result (detected) includes state information indicating that the power failure has not been recovered.

On the other hand, in a case where there is no power failure information corresponding to the position information, the disaster countermeasure system 103 transmits, to the information processing apparatus 101, an inquiry result (undetected) indicating that the occurrence of the power failure in the area indicated by the position information is not detected. In a case where the inquiry result (detected) is received, the communication control unit 703 does not transmit the disaster information including the captured image P to the disaster countermeasure system 103.

On the other hand, in a case where the inquiry result (undetected) is received, the communication control unit 703 transmits the disaster information including the captured image P to the disaster countermeasure system 103. For example, the communication control unit 703 transmits the disaster information including the captured image P to the disaster countermeasure system 103 in a case where there is a possibility that a power failure that has not been grasped (detected) by an electric power company has occurred.

Furthermore, the communication control unit 703 may determine whether or not the state information indicating that the power failure has been recovered is included in a case where the inquiry result (undetected) is received. Then, the communication control unit 703 may transmit the disaster information including the captured image P to the disaster countermeasure system 103 in a case where the state information indicating that the power failure has been recovered is included. For example, the communication control unit 703 transmits the disaster information including the captured image P to the disaster countermeasure system 103 in a case where there is a possibility that a power failure has occurred in an area determined to be recovered by an electric power company.

Note that the power failure information DB 130 may be included in the information processing apparatus 101. In this case, the communication control unit 703 determines, with reference to the power failure information DB 130, whether or not the received position information is included in the area for which the disaster information is registered in the disaster countermeasure system 103. Furthermore, the communication control unit 703 determines, with reference to the power failure information DB 130, whether or not the received position information is included in the area corresponding to the state indicating recovery from a disaster. The contents stored in the power failure information DB 130 are updated each time new disaster information is registered in the disaster countermeasure system 103, for example.

Furthermore, the communication control unit 703 may determine whether or not a distribution request of the power failure information distribution service is registered in association with a user of the information processing terminal 102. The power failure information distribution service is a service that notifies a user who has already registered the distribution request of power failure information of a distribution request area by push notification.

For example, when new power failure information is registered in the power failure information DB 130 or the power failure information in the power failure information DB 130 is updated, the new power failure information or the updated power failure information is transmitted to the user who has already registered the distribution request. Note that the power failure information distribution service may be implemented by the information processing apparatus 101 or may be implemented by the disaster countermeasure system 103.

Then, in a case where the distribution request is registered, the communication control unit 703 may set priority for the disaster information including the captured image P depending on whether or not the position information received before the reception of the captured image P is included in the distribution request area of the user. In this case, the communication control unit 703 transmits the disaster information for which the priority is set to the disaster countermeasure system 103.

For example, in a case where the received position information is included in the distribution request area of the user, the communication control unit 703 sets, for the disaster information including the captured image P, priority higher than that of a case where the received position information is not included in the distribution request area of the user. The priority is an index value indicating high credibility of the disaster information including the captured image P, and is represented by, for example, a numerical value or high or low.

In more detailed description, for example, the communication control unit 703 searches for user information corresponding to a user ID of the user of the information processing terminal 102 with reference to the user information DB 120 illustrated in FIG. 4. For example, when it is assumed that the user ID is “U001”, the user information 400-1 is searched for. In this case, the communication control unit 703 determines whether or not the received position information is included in any one of the distribution request areas 1 to 3 of the user information 400-1.

For example, in a case where a site indicated by the received position information is included in the distribution request area 1 “xxx, a-cho, A-gun, Tokushima”, the communication control unit 703 determines that the received position information is included in the distribution request area of the user. Note that, in a case where the user information corresponding to the user ID is not searched for, the communication control unit 703 determines that the distribution request is not registered in the power failure information distribution service.

For example, in a case where the received position information is included in the distribution request area of the user, the communication control unit 703 sets the priority “high” for the disaster information including the captured image P. On the other hand, in a case where the received position information is not included in the distribution request area of the user, the communication control unit 703 sets the priority “low” for the disaster information including the captured image P. Furthermore, in a case where the distribution request is not registered in the power failure information distribution service, the communication control unit 703 sets the priority “low” for the disaster information including the captured image P.

For example, when the received position information matches the distribution request area already registered in the power failure information distribution service being used by the user of the information processing terminal 102, the communication control unit 703 determines that the credibility of the information is high, and sets the priority “high” for the disaster information including the captured image P.

Furthermore, in a case where the distribution request of the power failure information distribution service is not registered in association with the user of the information processing terminal 102, the conversation control unit 702 may make an inquiry to the information processing terminal 102 as to whether or not to permit recording of information that may specify the individual user. For example, the conversation control unit 702 makes an inquiry to the information processing terminal 102 as to whether or not to permit recording (acquisition) of the user ID in the form of a conversation in the chatbot for disaster. Furthermore, the conversation control unit 702 may display, on the information processing terminal 102, a pop-up screen making the inquiry as to whether or not to permit recording (acquisition) of the user ID.

Then, the communication control unit 703 may transmit the disaster information including the captured image P to the disaster countermeasure system 103 in a case where an answer indicating that the recording of the information that may specify the individual user is permitted is received from the information processing terminal 102. On the other hand, the communication control unit 703 may not transmit the disaster information including the captured image P to the disaster countermeasure system 103 in a case where an answer indicating that the recording of the information that may specify the individual user is not permitted is received from the information processing terminal 102.

For example, the communication control unit 703 determines that information from a person who refuses recording of information that may specify the individual user (for example, a user ID) is significantly low in credibility, and does not transmit the information to the disaster countermeasure system 103.

Note that each functional unit of the information processing apparatus 101 described above may be implemented by a plurality of computers (for example, the information processing apparatus 101 and the information processing terminal 102) in the information collection system 100. Furthermore, each functional unit of the information processing apparatus 101 described above may be implemented by the information processing terminal 102.

(Screen Example of Chat Screen)

Next, a screen example of a chat screen displayed on the display 303 (refer to FIG. 3) of the information processing terminal 102 will be described with reference to FIGS. 8A and 8B.

FIGS. 8A and 8B are explanatory diagrams illustrating screen examples of the chat screen. In FIG. 8A, a chat screen 800 is an example of an operation screen that displays a conversation in the chatbot for disaster in the information processing terminal 102. In FIGS. 8A and 8B, an avatar av is a character representing a person in charge in an electric power company.

Here, a case is assumed where, as a result of asking a question to narrow down a cause of occurrence of a power failure by a conversation in the form of an interview in response to a message 801 “the light does not come on” from a user, an answer is input that specifies that the cause of the occurrence of the power failure is not an event that may be dealt with by a side of the user. Note that, in FIGS. 8A and 8B, a part of the conversations in the chatbot for disaster is excerpted and displayed.

In this case, a message 802 is output as a question from the avatar ay. The message 802 is a message prompting to transmit position information of a place where the power failure occurs. On the chat screen 800, for example, when the position information is input by an operation input of the user using the input device 304 illustrated in FIG. 3, map information 803 corresponding to the input position information is displayed.

Furthermore, the input position information is transmitted from the information processing terminal 102 to the information processing apparatus 101. As a result, in the information processing apparatus 101, it is determined whether or not the input position information corresponds to an area for which disaster information is registered in the disaster countermeasure system 103.

Note that a message may be input by selecting a box 810 on the chat screen 800. Furthermore, the message input to the box 810 may be transmitted to a side of the chatbot (information processing apparatus 101) by selecting a transmission button 811 on the chat screen 800.

Here, a case is assumed where it is determined that the input position information does not correspond to the area for which the disaster information is registered in the disaster countermeasure system 103.

In this case, as illustrated in FIG. 8B, messages 804 and 805 of the avatar av are output. The message 804 is a message indicating that there is no power failure grasped by the electric power company in an area corresponding to the input position information. The message 805 is a message prompting to capture an image of a service line to a building or an electric facility (such as a utility pole).

On the chat screen 800, for example, when captured image 806 captured by the camera 306 illustrated in FIG. 3 is input by an operation input of the user, the input captured image 806 is displayed. The captured image 806 is a photograph including a service line to a building where the power failure occurs and a utility pole.

Furthermore, when the captured image 806 is input on the chat screen 800, a message 807 of the avatar av is output. The message 807 is a message indicating that a worker will be arranged at the site because there is a possibility that the power failure has occurred due to damage to the service line.

Furthermore, the input captured image 806 is transmitted from the information processing terminal 102 to the information processing apparatus 101. When receiving the captured image 806, the information processing apparatus 101 transmits disaster information including the captured image 806 to the disaster countermeasure system 103. The disaster information includes, for example, the captured image 806, the input position information, and a user ID.

As a result, in the disaster countermeasure system 103, for example, when it is determined from the captured image 806 that there is the possibility that the service line or the like is damaged, a worker of the electric power company is dispatched to the site to conduct a site investigation. When a hidden power failure due to the damage to the service line or the like is detected in the site investigation, the electric power company copes with the accident.

Furthermore, when the hidden power failure is detected by the information provided by the user, power failure information regarding the detected hidden power failure is registered in the power failure information DB 130. With this configuration, it is possible to register power failure information regarding not only a power failure due to damage to a high-voltage line or the like detected by alive monitoring in the disaster countermeasure system 103 but also the hidden power failure detected on the basis of the disaster information including the captured image P (for example, captured image 806) provided by a resident or the like.

Furthermore, when the hidden power failure is detected by the information provided by the user, for example, an electric power company point that may be used for payment of an electricity charge is given for cooperating in the detection of the hidden power failure. The user to whom the electric power company point is given is specified from, for example, the user ID included in the disaster information.

On the other hand, when it is found to be mischievous in the site investigation, the user ID included in the disaster information may be registered in a blacklist. The blacklist is shared by, for example, the information processing apparatus 101 and the disaster countermeasure system 103, and is used to determine validity of the user who provided the information.

For example, when receiving the captured image P from the user registered in the blacklist, the information processing apparatus 101 includes information indicating that the user is registered in the blacklist in the disaster information and transmits the disaster information to the disaster countermeasure system 103. With this configuration, in the disaster countermeasure system 103, it is possible to grasp that the information is provided by the user registered in the blacklist, and it is possible to take actions such as warning the user.

(Operation Example of Information Collection System 100)

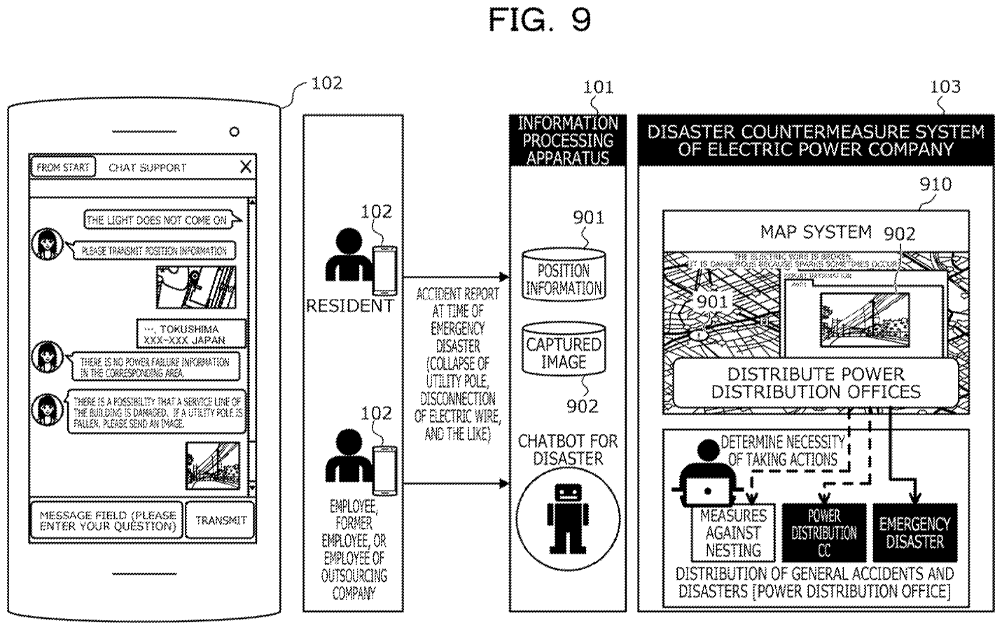

Next, an operation example of the information collection system 100 will be described with reference to FIG. 9.

FIG. 9 is an explanatory diagram illustrating the operation example of the information collection system 100. In FIG. 9, the information processing terminals 102 used by a resident who receives electric power supply from an electric power company and an employee, a former employee, or an employee of an outsourcing company of the electric power company are displayed.

In a conversation in the chatbot for disaster in the information processing terminal 102, when position information 901 and captured image 902 are input, the input position information 901 and captured image 902 are transmitted to the information processing apparatus 101 as an accident report at the time of an emergency disaster. As a result, the information processing apparatus 101 receives the position information 901 and the captured image 902 from the information processing terminal 102.

In the information processing apparatus 101, when it is determined that the received position information 901 and captured image 902 are not information regarding a power failure grasped by the electric power company, the received position information 901 and captured image 902 are transmitted to the disaster countermeasure system 103 of the electric power company.

In the disaster countermeasure system 103, for example, necessity of taking actions is determined from the captured image 902, and by linking with an existing map system 910, neighboring utility poles are searched for from the position information 901, and distribution of power distribution offices that cope with the accident is performed. With this configuration, it is possible to make an accurate command, and it is possible to carry out a site investigation and a recovery response based on total optimization.

(Information Collection Processing Procedure of Information Processing Apparatus 101)

Next, an information collection processing procedure of the information processing apparatus 101 will be described with reference to FIGS. 10 to 12.

FIGS. 10 to 12 are flowcharts illustrating an example of the information collection processing procedure of the information processing apparatus 101. In the flowchart of FIG. 10, first, the information processing apparatus 101 determines whether or not an instruction to start a conversation in the chatbot for disaster has been received from the information processing terminal 102 (Step S1001). Here, the information processing apparatus 101 stands by for receiving the instruction to start a conversation in the chatbot for disaster (Step S1001: No).

When receiving the instruction to start a conversation in the chatbot for disaster (Step S1001: Yes), the information processing apparatus 101 starts a conversation in the chatbot for disaster to the information processing terminal 102 by using the talk script TP (Step S1002). The talk script TP is a talk script that defines a flow of a conversation that is performed when a power failure occurs due to a disaster.

Next, the information processing apparatus 101 inquires whether or not a power failure occurs in the whole house in the conversation in the chatbot for disaster (Step S1003). Here, in a case where the power failure does not occur in the whole house (Step S1003: No), the information processing apparatus 101 inquires whether or not the power failure occurs in one of appliances in the conversation in the chatbot for disaster (Step S1004).

Here, in a case where the power failure occurs in one of the appliances (Step S1004: Yes), the information processing apparatus 101 displays a countermeasure for a failure or the like in the conversation in the chatbot for disaster (Step S1005), and terminates the series of processing according to the present flowchart. The countermeasure for a failure or the like is, for example, a method for dealing with burn out of a light bulb or a fluorescent lamp, or the like.

On the other hand, in a case where the power failure occurs in a plurality of appliances (Step S1004: No), the information processing apparatus 101 inquires whether or not an indoor breaker is tripped in the conversation in the chatbot for disaster (Step S1006). Here, in a case where the indoor breaker is tripped (Step S1006: Yes), the information processing apparatus 101 displays an operation method of the indoor breaker in the conversation in the chatbot for disaster (Step S1007), and terminates the series of processing according to the present flowchart.

On the other hand, in a case where the indoor breaker is not tripped (Step S1006: No), the information processing apparatus 101 connects the information processing terminal 102 and the operator terminal 104, switches the conversation by the chatbot to a manned conversation by an operator (Step S1008), and terminates the series of processing according to the present flowchart.

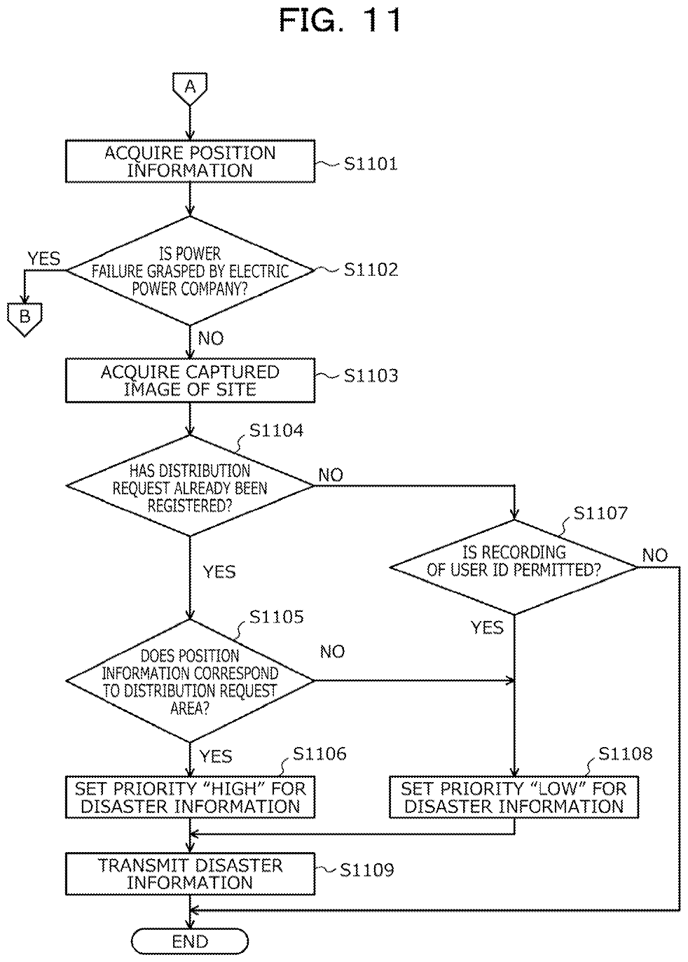

Furthermore, in a case where the power failure occurs in the whole house in Step S1003 (Step S1003: Yes), the information processing apparatus 101 inquires whether or not the power failure occurs only in the own house in the conversation in the chatbot for disaster (Step S1009). Here, in the case where the power failure does not occur only in the own house (Step S1009: No), the information processing apparatus 101 proceeds to Step S1101 indicated in FIG. 11.

On the other hand, in a case where the power failure occurs only in the own house (Step S1009: Yes), the information processing apparatus 101 inquires whether or not an outdoor breaker is tripped in the conversation in the chatbot for disaster (Step S1010). Here, in a case where the outdoor breaker is tripped (Step S1010: Yes), the information processing apparatus 101 displays an operation method of the outdoor breaker (Step S1011), and terminates the series of processing according to the present flowchart.

On the other hand, in a case where the outdoor breaker is not tripped (Step S1010: No), the information processing apparatus 101 proceeds to Step S1101 indicated in FIG. 11.

In the flowchart of FIG. 11, first, the information processing apparatus 101 acquires position information input to a message prompting to transmit position information in the conversation in the chatbot for disaster (Step S1101). Then, the information processing apparatus 101 determines whether or not the power failure is grasped by an electric power company on the basis of the acquired position information (Step S1102). The processing of this step corresponds to hidden power failure check processing.

For example, in a case where the acquired position information corresponds to an area for which disaster information is registered in the disaster countermeasure system 103, the information processing apparatus 101 determines that the power failure is grasped by the electric power company. In this case, the information processing apparatus 101 acquires, from the disaster countermeasure system 103, power failure information regarding the power failure occurring in the area corresponding to the acquired position information. Furthermore, in a case where the acquired position information does not correspond to the area for which the disaster information is registered in the disaster countermeasure system 103, the information processing apparatus 101 determines that the power failure is not grasped by the electric power company.

In a case where the power failure is not grasped by the electric power company in Step S1102 (Step S1102: No), in the conversation in the chatbot for disaster, the captured image P of the site input for a message prompting to capture an image of a service line to a building or an electric facility (such as a utility pole) is acquired (Step S1103).

Next, with reference to the user information DB 120, the information processing apparatus 101 determines whether or not a user of the information processing terminal 102 has already registered a distribution request in the power failure information distribution service (Step S1104). Here, in a case where the distribution request has already been registered (Step S1104: Yes), the information processing apparatus 101 determines whether or not the acquired position information corresponds to a distribution request area of the user (Step S1105).

Here, in a case where the acquired position information corresponds to the distribution request area of the user (Step S1105: Yes), the information processing apparatus 101 sets priority “high” for disaster information including the captured image P (Step S1106), and proceeds to Step S1109. On the other hand, in a case where the acquired position information does not correspond to the distribution request area of the user (Step S1105: No), the information processing apparatus 101 proceeds to Step S1108.

Furthermore, in a case where the distribution request has not already been registered in Step S1104 (Step S1104: No), the information processing apparatus 101 inquires whether or not to permit recording of a user ID in the conversation in the chatbot for disaster (Step S1107).

Here, in a case where recording of the user ID is not permitted (Step S1107: No), the series of processing according to the present flowchart is terminated. At this time, the information processing apparatus 101 may output a message indicating that the conversation in the chatbot for disaster is terminated.

On the other hand, in a case where recording of the user ID is permitted (Step S1107: Yes), the information processing apparatus 101 sets priority “low” for the disaster information including the captured image P (Step S1108). Then, the information processing apparatus 101 transmits the disaster information including the captured image P to the disaster countermeasure system 103 (Step S1109), and terminates the series of processing according to the present flowchart.

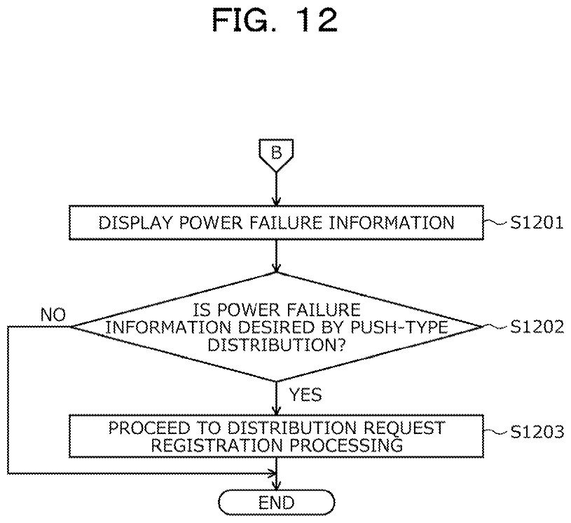

Furthermore, in a case where the power failure is grasped by the electric power company in Step S1102 (Step S1102: Yes), the information processing apparatus 101 proceeds to Step S1201 indicated in FIG. 12.

In the flowchart of FIG. 12, first, the information processing apparatus 101 displays the power failure information regarding the power failure occurring in the area corresponding to the acquired position information in the conversation in the chatbot for disaster (Step S1201). The power failure information includes, for example, information regarding a cause of the power failure and a prospect of recovery.

Next, the information processing apparatus 101 inquires whether or not the power failure information is desired by push-type distribution in the conversation in the chatbot for disaster (Step S1202). Here, in a case where the power failure information is not desired by the push-type distribution (Step S1202: No), the information processing apparatus 101 terminates the series of processing according to the present flowchart.

On the other hand, in a case where the power failure information is desired by the push-type distribution (Step S1202: Yes), the information processing apparatus 101 proceeds to distribution request registration processing of the power failure information distribution service (Step S1203), and terminates the series of processing according to the present flowchart.

With this configuration, it is possible to collect useful information for detection of a hidden power failure by using two-way communication linked with the chatbot for disaster.

As described above, according to the information processing apparatus 101 according to the embodiment, it is possible to start, in response to reception of an instruction to start a conversation in a chatbot for disaster from the information processing terminal 102, a conversation in the chatbot for disaster to the information processing terminal 102. Then, according to the information processing apparatus 101, it is possible to transmit, in a case where the captured image P is received in the conversation in the chatbot for disaster, disaster information including the captured image P to the disaster countermeasure system 103 on the basis of content of a conversation before the reception of the captured image P. The captured image P is, for example, a photograph or a moving image received from the information processing terminal 102 for a message that is output in the conversation in the chatbot for disaster and prompts to capture an image of a situation of the site. Furthermore, the disaster information includes, for example, position information received before the reception of the captured image P.

With this configuration, it is possible to enable collection of useful information for detection of a hidden power failure that may not be detected by alive monitoring in the disaster countermeasure system 103 by enabling real-time transmission of information from residents to an electric power company using two-way communication linked with the chatbot for disaster. For example, by including the position information and the captured image (photograph or moving image) of the site in the disaster information, it is possible to accurately transmit a situation of the accident occurred at the site to the electric power company.

Furthermore, according to the information processing apparatus 101, it is determined whether or not the position information received before the reception of the captured image P is included in an area for which disaster information is registered in the disaster countermeasure system 103, and in a case where it is determined that the received position information is not included in the registered area, it is possible to transmit the disaster information including the captured image P to the disaster countermeasure system 103.

With this configuration, it is possible to remove information regarding known power failures grasped by the electric power company as noise, and to upload useful information for detection of a hidden power failure to the disaster countermeasure system 103. For example, it is possible to prevent unnecessary information from being uploaded to the electric power company, causing unnecessary trouble and confusion.

Furthermore, according to the information processing apparatus 101, it is possible to transmit the disaster information including the captured image P to the disaster countermeasure system 103 in a case where the received position information is included in an area corresponding to a state indicating recovery from a disaster with reference to information managed by the disaster countermeasure system 103, in which an area and a state of a disaster are associated with each other.

With this configuration, it is possible to upload, to the disaster countermeasure system 103, useful information for detection of a local hidden power failure occurring in an area managed to be recovered by the electric power company.

Furthermore, according to the information processing apparatus 101, it is possible to transmit the disaster information including the captured image P to the disaster countermeasure system 103 in a case where a specific answer is received from the information processing terminal 102 to a predetermined question regarding an occurrence situation of a power failure in the conversation in the chatbot for disaster before the reception of the captured image P.

With this configuration, it is possible to secure credibility of information itself to be uploaded by preprocessing an event that may be dealt with by a side of a user (a breaker is tripped, a light bulb is burned out, and the like) by a conversation in the form of an interview, and preventing the information from being uploaded to a side of the electric power company.

Furthermore, according to the information processing apparatus 101, in a case where the captured image P is received, it is possible to determine whether or not a distribution request of a power failure information distribution service is registered in association with a user of the information processing terminal 102. Then, according to the information processing apparatus 101, in a case where the distribution request is registered, it is possible to set priority for the disaster information including the captured image P depending on whether or not the position information received before the reception of the captured image P is included in a distribution request area of the user. For example, in a case where the received position information is included in the distribution request area of the user, the information processing apparatus 101 sets, for the disaster information including the captured image P, priority higher than that of a case where the received position information is not included in the distribution request area of the user.

With this configuration, when the position information of the site matches the distribution request area already registered in the power failure information distribution service being used by the user of the information processing terminal 102, it is possible to determine that the credibility of the information is high, and set the priority “high” for the disaster information including the captured image P. On the side of the electric power company, it is possible to determine a matter that needs to be coped with with priority according to the priority set for the disaster information. For example, since disaster information with the priority “high” has higher credibility than disaster information with the priority “low”, it is possible to determine that the matter needs to be coped with with priority.

Furthermore, according to the information processing apparatus 101, in a case where the distribution request is not registered, it is possible to make an inquiry to the information processing terminal 102 as to whether or not to permit recording of information that may specify the individual user. Then, according to the information processing apparatus 101, in a case where an answer indicating that the recording is permitted is received from the information processing terminal 102, it is possible to transmit the disaster information including the captured image P to the disaster countermeasure system 103, and in a case where an answer indicating that the recording is not permitted is received from the information processing terminal 102, it is possible not to transmit the disaster information including the captured image P to the disaster countermeasure system 103.

With this configuration, it is possible to determine that information from a person who refuses recording of information that may specify the individual user (for example, a user ID) is significantly low in credibility, and may not transmit the information to the electric power company. For example, for a user who does not use the power failure information distribution service and whose validity has not been confirmed in advance, a user ID registered for use of the communication tool (chat application) may be used to perform personal authentication and ensure credibility of the information. Furthermore, since it is not needed for a user to input a name, an address, and the like for the personal authentication, convenience at the time of an emergency may be ensured.

From these facts, according to the information processing apparatus 101, it is possible to detect a hidden power failure that may not be detected by alive monitoring of an electric power company, and to carry out a site investigation and a recovery response based on total optimization, thereby shortening a period until recovery. Furthermore, residents may avoid a prolonged power failure and may live with peace of mind.

Note that the information collection method described in the present embodiment may be implemented by a computer such as a personal computer or a workstation executing a program prepared in advance. The present information collection program is recorded on a computer-readable recording medium such as a hard disk, a flexible disk, a CD-ROM, a DVD, or a USB memory, and is read from the recording medium to be executed by a computer. Furthermore, the present information collection program may be distributed via a network such as the Internet.

Furthermore, the information processing apparatus 101 described in the present embodiment may also be implemented by a special-purpose integrated circuit (IC) such as a standard cell or a structured application specific integrated circuit (ASIC) or a programmable logic device (PLD) such as a field-programmable gate array (FPGA).

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an information collection program for causing a computer to execute processing comprising:
starting, in response to reception of an instruction to start a conversation in a chatbot for disaster from an information processing terminal, a conversation in the chatbot to the information processing terminal; and
transmitting, in a case where a captured image is received in the conversation, disaster information that includes the captured image to a disaster countermeasure system on the basis of content of a conversation before the reception of the captured image.

2. The non-transitory computer-readable recording medium according to claim 1, for causing the computer to execute the processing further comprising
receiving position information regarding to the information processing terminal before the reception of the captured image, wherein
in the processing of transmitting,
the disaster information that includes the captured image is transmitted to the disaster countermeasure system in a case where the position information is included in an area that corresponds to a state that indicates recovery from a disaster with reference to information managed by the disaster countermeasure system, in which an area and a state of a disaster are associated with each other.

3. The non-transitory computer-readable recording medium according to claim 1, wherein the disaster information that includes the captured image is transmitted to the disaster countermeasure system in a case where a specific answer is received from the information processing terminal to a predetermined question regarding an occurrence situation of a power failure in the conversation before the reception of the captured image.

4. The non-transitory computer-readable recording medium according to claim 1, for causing the computer to execute the processing further comprising:
determining, in a case where the captured image is received, whether or not a distribution request of a power failure information distribution service is registered in association with a user of the information processing terminal; and
setting, in a case where the distribution request is registered, priority for the disaster information that includes the captured image depending on whether or not position information received before the reception of the captured image is included in a distribution request area of the user.

5. The non-transitory computer-readable recording medium according to claim 1, wherein the disaster information includes the captured image and position information received before the reception of the captured image.

6. The non-transitory computer-readable recording medium according to claim 4, wherein
in the processing of setting,
in a case where the position information is included in the distribution request area of the user, priority higher than priority of a case where the position information is not included in the distribution request area of the user is set for the disaster information that includes the captured image.

7. The non-transitory computer-readable recording medium according to claim 4, for causing the computer to execute the processing further comprising
making, in a case where the distribution request is not registered in association with the user, an inquiry to the information processing terminal as to whether or not to permit recording of information that enables specification of the individual user, wherein
in the processing of transmitting,
in a case where an answer that indicates that the recording is permitted is received from the information processing terminal, the disaster information that includes the captured image is transmitted to the disaster countermeasure system, and
in a case where an answer that indicates that the recording is not permitted is received from the information processing terminal, the disaster information that includes the captured image is not transmitted to the disaster countermeasure system.

8. The non-transitory computer-readable recording medium according to claim 1, wherein the captured image is a photograph or a moving image received from the information processing terminal for a message that is output in the conversation and prompts to capture an image of a situation of a site.

9. The non-transitory computer-readable recording medium according to claim 1, wherein the disaster countermeasure system is a disaster countermeasure system that manages power failure information regarding a power failure that occurs within a jurisdiction area of an electric power company.

10. An information collection method comprising:
starting, in response to reception of an instruction to start a conversation in a chatbot for disaster from an information processing terminal, a conversation in the chatbot to the information processing terminal; and
transmitting, in a case where a captured image is received in the conversation, disaster information that includes the captured image to a disaster countermeasure system on the basis of content of a conversation before the reception of the captured image.

11. An information processing apparatus comprising:
a memory; and
a processor coupled to the memory and configured to:
start, in response to reception of an instruction to start a conversation in a chatbot for disaster from an information processing terminal, a conversation in the chatbot to the information processing terminal; and
transmit, in a case where a captured image is received in the conversation, disaster information that includes the captured image to a disaster countermeasure system on the basis of content of a conversation before the reception of the captured image.
